(19) United States
(12) Patent Application Publication
(10) Pub. No.: US 2017/0173545 A1
(43) Pub. Date: Jun. 22, 2017

(54) DEVICE FOR MIXING A SUBSTANCE WITHIN A CONTAINER

(71) Applicant: Ronald D. Myer, Kokomo, IN (US)

(72) Inventor: Ronald D. Myer, Kokomo, IN (US)

(21) Appl. No.: 14/977,738

(22) Filed: Dec. 22, 2015

(51) Int. Cl. B01F 9/00

(52) U.S. Cl. CPC B01F 9/0016; B01F 2009/0059

(57) ABSTRACT

A device for mixing a substance within a container. A mixer includes a motor driven roller positioned between a pair of rods. A cylindrical tube is removably mounted against the roller and is rotatable therewith with the rods limiting sideways motion. The containers holding the materials to be mixed are inserted into the tube and rotated therewith. A frame is provided to hold multiple mixers.

### BACKGROUND OF THE INVENTION

Field of the Invention

The present invention is in the field of devices for moving a container of material in such a manner to cause mixing of the material within the container.

Description of the Prior Art

A variety of methods have been used to mix material within a container. For example, various types of agitators such as stirrers may be extended into the container and rotated to mix the material. Egg beaters are one such example. A further type is to mount the container between two plates which are then pivoted shaking the container such as found when mixing paint in a can of paint.

Despite the prior devices, there is a need for mixing material within small containers such as containers holding nail polish. In such a case, the container may be produced from a glass or plastic and will easily break if not handled properly during the mixing stage.

In view of the above, I have developed a mixer wherein the container is positioned atop and in contact with a rotatable roller with sideways movement of the container limited by a pair of rods that extend lengthwise with the roller. In the event the container has an outer polygonal shape, then a tube is provided for receiving the container. In such a case, the container having the material therein is inserted into a complementary shaped polygonal cavity formed in the tube, with the tube then positioned atop and in contact with the roller.

### SUMMARY OF THE INVENTION

A device for mixing a substance within a container comprising a main frame. A first roller is rotatably mounted to the frame and has a first roller outer cylindrical surface. An electric motor has a rotatable output connected to the roller to rotate same. A first guide is mounted to the frame and has a first holding space adjacent the roller for receiving and rotating the container for mixing the substance within the container.

It is an object of the present invention to provide a mixer to receive and mix material within variable sized containers.

Another object of the present invention is to provide a mixer that will limit sideways motion of a container of material while rotating same.

A further object of the present invention is to provide a display of mixers that will simultaneously mix material within containers held on the mixers.

Related objects and advantages will be apparent from the following description.

### BRIEF DESCRIPTION OF THE DRAWINGS

FIG. 1 is a top perspective view of a mixer for rotating a container having a polygonal outer shape having material to be mixed.

FIG. 2 is the same view as FIG. 1 only showing the mixer rotating a container having a round outer shape.

FIG. 3 is a side view of a typical container having material therein to be mixed with the container having a polygonal outer shape.

FIG. 4 is a side view of a typical container having material therein to be mixed with the container having a round outer shape.

FIG. 5 is an enlarged cross-sectional view taken along a line and viewed in the direction of arrows 5-5 of FIG. 1 with container 37 inserted into tube 50.

FIG. 6 is an enlarged cross-sectional view taken along a line and viewed in the direction of arrows 6-6 of FIG. 2.

FIG. 7 is a perspective view of an alternate embodiment of a single holder for displaying multiple mixers such as shown in FIG. 1.

FIG. 8 is a perspective view of the preferred embodiment of a pair of holders for displaying multiple mixers such as shown in FIG. 1

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

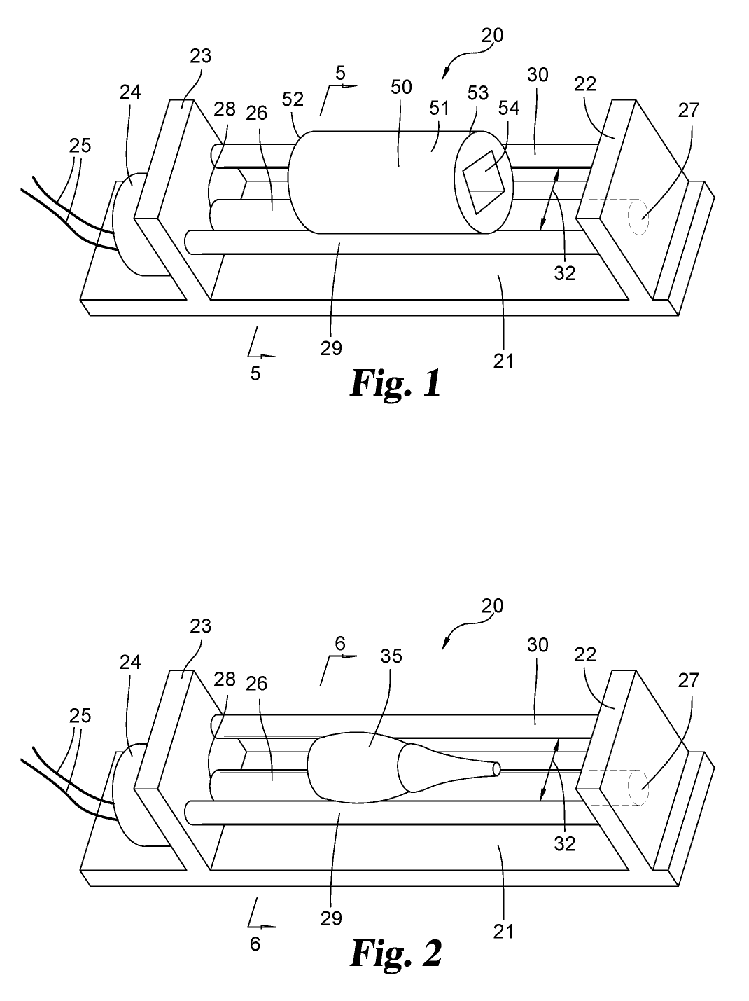

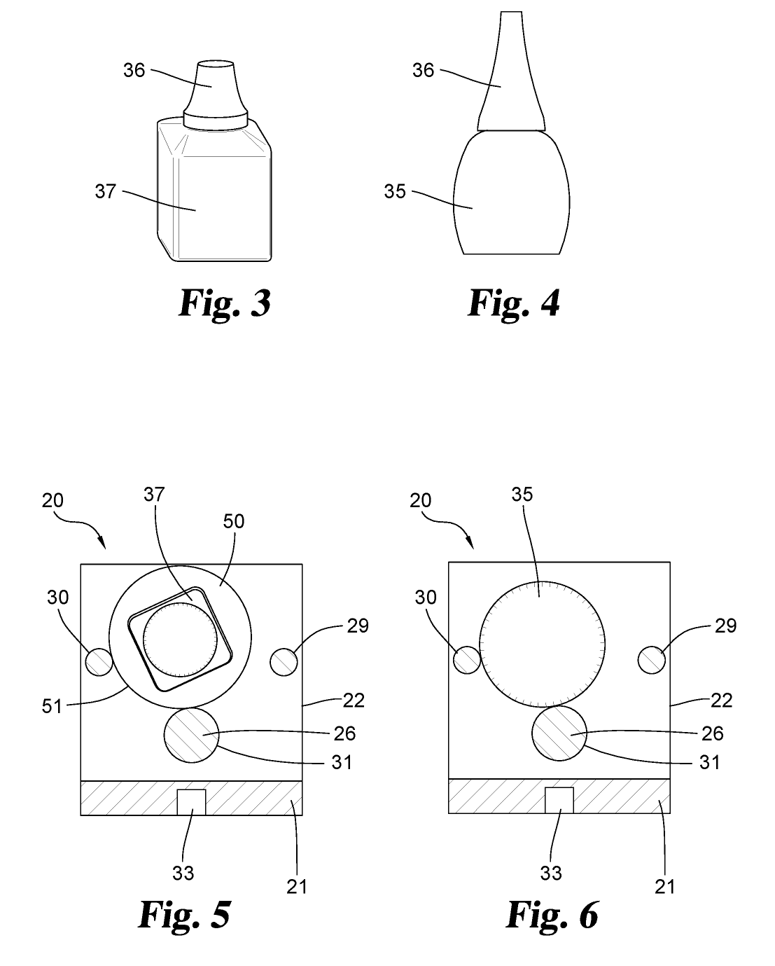

Referring now more particularly to FIG. 1, there is shown a mixer 20 for rotating a container 37 (FIG. 3) having material therein to be mixed. Mixer 20 includes a bottom base plate or wall 21 with a pair of side walls 22 and 23 fixedly secured thereto and extending perpendicularly from the bottom wall. A roller 26 has its opposite ends 27 and 28 rotatably mounted respectively to side walls 22 and 23. Electric motor 24 is mounted to the outwardly facing surface of side wall 23 and includes a rotatable output fixedly connected to end 28 of roller 26. An option is to provide bearings in side walls 22 and 23 for rotatably receiving ends 27 and 28 of roller 26. Motor wires 25 are connected to a source of electrical energy. An option is to provide an on/off switch connected to wires 25.

Two rods 29 and 30 have their opposite ends connected to side walls 22 and 23 and are spaced apart distance 32 that is greater than either the outside diameter of tube 50 or the outside diameter of round container 35 (FIG. 4). In case the container of material to be mixed has a non-round outer shape, as shown for container 37, then cylindrical tube 50 is provided. Cylindrical tube 50 (FIG. 1) has a polygonal cavity 54 extending from end 52 to end 53. Thus, if the container has an outer polygonal shape, such as, a square outer cross section, then cavity 54 has a square cross section into which the container 37 may be inserted and held. Tube 50 is then placed atop roller 26 whereas if a container with a round shape is selected, such as container 35, then the container rests atop the roller without tube 50 being utilized. Typically the containers 35 and 37 have a cap 36. It is to be understood that the present invention include tubes 50 having a variety of different polygonal internally shaped cavities.

Operation of the mixer will now be explained referring specifically to FIG. 1. Cylindrical tube 50 has an outside cylindrical surface 51 in rolling contact with the outside cylindrical surface 31 (FIG. 5) of roller 26. The outside diameter of tube 50 is less than the distance 32 (FIG. 1) between rods 29 and 30. Thus, tube 50 is positioned between the rods and extends downward so that tube surface 51 is in contact with the roller outside surface 31 while the tube is in contact with only one of the rods 29 or 30. As roller 26 is rotated by motor 24, surface 31 is in driving contact with surface 51 of tube 50. With roller 26 rotating in a first direction, tube 50 will rotate in the opposite direction. Similarly, container 35 is placed atop and in contact with the roller outside surface 31 while the container is in contact with only one of the rods 29 or 30. Roller 26 is in driving contact with the outside surface of container 35.

Prior to placement of tube 50 between rods 29 and 30, the container 37 is inserted into cavity 54 of tube 50. In the event, the container has a round shape (FIG. 4), then a tube is not used and instead, the container 35 is placed atop roller 26 between the two rods 29 and 30.

Rods 29 and 30 provide a guide forming a holding space above the roller to receive the round container 35 or cylindrical tube 50. Each is sized to fit into the holding space thereby preventing either container 35 or tube 50 from being thrown out from the mixer as the roller rotates. Essentially, the guide formed by rods 29 and 30 provide stop surfaces to limit the sideways motions of the container 35 and tube 50 as they are rotated.

Many variations are contemplated and included in the present invention. For example, the container such as depicted in FIG. 3 may be inserted into cavity 54 through end 53 whereas a second identical container may be inserted into the cavity through the opposite end 52 of the tube. In such a manner, both containers can be rotated simultaneously by a single tube 50. Rods 29 and 30 are parallel to the axis of rotation of roller 26. Nevertheless, it is to be understood that alternate stop services such as walls may be utilized in lieu of rods 29 and 30.

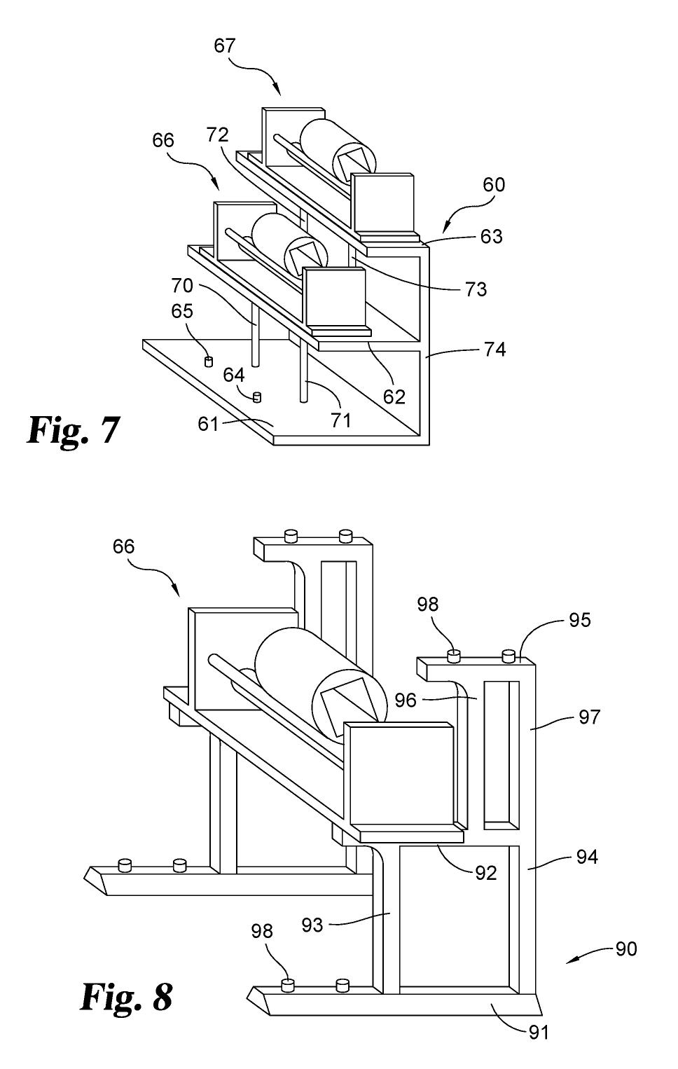

A holder 60 (FIG. 7) is provided to hold and display multiple mixers 20 enabling the user to employ a plurality of mixers having a plurality of containers to expedite the mixing of material within the containers. In the embodiment shown in the drawing, holder 60 is configured as a staircase having multiple levels formed by walls 61, 62 and 63 which extend horizontally outwardly from back wall 74 with each receiving a separate mixer 20. Each wall 61-63 includes a pair of posts extendable into the bottom wall 21 of each mixer. Closed hole 33 is shown in FIG. 5 formed in bottom wall 21 to receive one of the posts 64 or 65 (FIG. 7). Bottom wall 21 includes a second closed hole to receive the remaining post thereby removably securing mixer 20 atop the posts. Posts 70 and 71 extend upwardly from bottom wall 61 and through wall 62 with the top ends of posts 70 and 71 forming posts extending into closed holes 33 of the bottom wall of the mixer resting atop wall 62. Likewise, posts 72 and 73 extend upwardly from wall 62 and through wall 63 having top ends forming posts extending into closed holes 33 of the bottom wall of the mixer resting atop wall 63. A pair of parallel mixers 66 and 67 have been shown as removably mounted to walls 62 and 63 whereas wall 61 is shown as not having a mixer mounted thereto in order to illustrate posts 64 and 65. The mixers 66 and 67 mounted atop walls 62 and 63 are identical to mixer 20. All of the mixers mounted atop holder 60 are held in parallel relationship and may be connected to a source of electrical energy thereby allowing simultaneously mixing on all posts 61-63.

Holder 60 (FIG. 7) is the alternate embodiment of the holder whereas Holder 90 (FIG. 8) is the preferred embodiment of the holder. Holder 90 is configured as a staircase similar to holder 60 and has multiple levels formed by parallel walls 91, 92 and 95 which are cantileveredly mounted to and extend horizontally outwardly from a back wall composed of aligned and joined walls 94 and 97. Whereas a single holder 60 is used to support a mixer on each wall 61-63, a pair of holders 90 are required to support a mixer on each wall 91, 92, and 95. Each wall 91, 92 and 95 receive a separate mixer 20. Intermediate walls 93 and 96 are parallel to walls 94 and 97 and are joined to and support respectively walls 91/92 and 92/95. Each wall 91, 92, and 95 includes a pair of posts 98 extendable into the closed holes 33 of the bottom wall 21 of each mixer. In the case of using holder 90, bottom wall 21 of each mixer includes a pair of downwardly opening closed holes located at one end of the bottom wall 21 and a second pair of downwardly opening closed holes 33 located at the opposite end of bottom wall 21. As a result, each bottom wall 21 has a total of four closed holes which open downwardly. Thus, a first holder 90 is located at one end of bottom wall 21 with a first pair of posts extending into bottom wall 21 and a second holder 90 is located at the opposite end of bottom wall 21 with a second pair of posts extending into bottom wall 21 thereby supporting the mixer at its opposite ends by a pair of holders 90. Similarly, a mixer 20 may be mounted atop middle wall 92 and a third mixer may be mounted atop the top wall 95. All of the mixers mounted atop holder 90 are held in parallel relationship and may be connected to a source of electrical energy thereby allowing simultaneously mixing on all levels.

Variations in the invention are possible in the present invention. For example, any material may be used metal, wood or plastic to produce the mixer. The plastic could be thermoset or thermoplastic. Likewise, an alternate or direct current motor may be utilized and any type of motor may be selected, such as, a synchronous motor. Best results have been obtained by keeping the rpm of the roller less than 150 rpm. In the preferred embodiment, the rpm for the roller was 30 rpm. Excellent results have been obtained by covering the roller with a heat shrink cover to increase the friction between the roller and the tube. A variety of materials may be mixed by rotating the containers such as paint and nail polish.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A device for mixing substances within containers comprising:
a main frame;
a first roller rotatably mounted to said frame and having a first roller outer cylindrical surface;
an electric motor having a rotatable output connected to said roller to rotate same;
a first guide mounted to said frame and having a first holding space adjacent said roller; and,
a first cylindrical tube removably located adjacent said roller and having a tube outer cylindrical surface contacting said roller outer cylindrical surface, said tube sized to fit in said holding space and having a cavity into which a container is removably positioned with said cavity sized to hold the container and rotate the container as said roller rotates said tube mixing substance within the container.

2. The device of claim 1 wherein said tube has a first end and a second end with said cavity extending through said first end and said second end allowing a container to fit into said cavity through said first end and another container to fit in said cavity through said second end allowing rotation of both containers as said tube rotates.

3. The device of claim 1 wherein said cavity is polygonal.

4. The device of claim 1 wherein said cavity is square.

5. The device of claim 1 wherein said guide includes a pair of spaced apart rods mounted to said main frame with said rods parallel with said roller, said rods are spaced apart a distance greater than the outside diameter of said tube allowing said tube to rest atop said roller while in contact with only one of said rods.

6. The device of claim 5 wherein said main frame includes a first end wall and a second end wall with said rods mounted thereto and extending therebetween, said roller has a first end rotatably mounted to said first end wall and a second end rotatably mounted to said second end wall, said motor is mounted to second end wall.

7. The device of claim 1 and further comprising:
a second main frame;
a second roller rotatably mounted to said second main frame and having a second roller outer cylindrical surface;
a second guide mounted to said second main frame and having a second holding space adjacent said second roller; and,
a second cylindrical tube removably located adjacent said second roller and having a second tube outer cylindrical surface contacting said second roller outer cylindrical surface, said second cylindrical tube sized to fit in said second holding space and having a second cavity into which a container is removably positioned with said second cavity sized to hold and rotate same as said second roller rotates.

8. The device of claim 7 and further comprising:
a holder for removably supporting said first main frame and said second main frame.

9. The device of claim 7 wherein:
said holder has a first space for holding said first frame and having a second space for holding said second frame arranging said first roller and said second roller in parallel relationship.

10. A device for rotating containers holding substances to be mixed comprising:
frame means;
roller means mounted to said frame means;
motor means mounted to said frame means and connected to said roller means for rotating same;
guide means mounted to said frame means to define space over said roller means; and,
tube means fitable in said space while in contact with said roller means, said tube means including cavities to receive containers which hold substances that are mixed as said roller means contact and rotate said tube means which in turn rotate the containers.

11. The device of claim 10 wherein:
said frame means includes a plurality of main frames which include first end walls and second end walls between which said roller means are rotatably mounted, said frame means further includes a frame holder upon which said main frames are held and displayed.

12. The device of claim 11 wherein:
said main frames include bottom walls connected to said first end walls and second end walls, said bottom walls have post holes whereas said frame holder has a plurality of posts extendable into said post holes for securing said main frames thereto.

13. The device of claim 12 wherein:
said tube means include cylindrical tubes removably located adjacent said roller means, said tubes have tube outer cylindrical surfaces contacting said roller means, said tubes sized to fit in said space and have cavities into which containers are removably positioned with said cavities sized to hold the containers and rotate the containers as said roller means rotate said tubes mixing substance within the containers.

14. The device of claim 13 wherein said tubes have first ends and second ends with said cavities extending through said first ends and said second ends allowing containers to fit into said cavities through said first ends and said second ends allowing rotation of the containers as said tube means rotate.

15. A mixer for mixing a substance within a container comprising:
a main frame;
a roller rotatably mounted to said frame and having a roller outer cylindrical surface;
an electric motor having a rotatable output connected to said roller to rotate same;
a guide mounted to said frame and having a holding space adjacent said roller, said guide includes a pair of rods extending parallel with said roller with said rods spaced apart a distance greater than the outside diameter of a container having the material to be mixed, said container fits in said holding space positioning said container atop and in contact with said roller and only one of said rods when rotated.

16. The mixer of claim 15 wherein said main frame includes a first end wall and a second end wall with said rods mounted thereto and extending therebetween, said roller has a first end rotatably mounted to said first end wall and a second end rotatably mounted to said second end wall, said motor is mounted to second end wall and connected to said second end of said roller.

17. The mixer of claim 16 wherein said mixer has opposite ends and further comprising a pair of holders removably holding said opposite ends of said mixer.

18. The device of claim 16 wherein:
said holder has a first space for holding a mixer and a second space above said first space for holding another mixer in parallel relationship.

19. The device of claim 18 wherein said holder includes a bottom wall and a top wall forming said first space and said space each with posts extending upwardly, said mixer includes downwardly opening holes mountingly receiving said posts.
